(19) United States
(12) Patent Application Publication
(10) Pub. No.: US 2020/0209124 A1
(43) Pub. Date: Jul. 2, 2020

(54) DEVICE AND METHOD FOR INTERFACING TWO SEPARATION TECHNIQUES

(71) Applicant: UNIVERSITY OF TASMANIA, Tasmania (AU)

(72) Inventors: Elisenda Fornells Vernet, Hobart, Tasmania (AU); Michael Charles Breadmore, Hobart, Tasmania (AU)

(21) Appl. No.: 16/614,961

(22) PCT Filed: May 21, 2018
(86) PCT No.: PCT/AU2018/050485

§ 371 Date: Nov. 19, 2019

(30) Foreign Application Priority Data
May 19, 2017 (AU) 2017901898

(51) Int. Cl. G01N 1/40; G01N 30/46; G01N 30/12; B01D 61/36

(52) U.S. Cl. CPC G01N 1/4022; G01N 30/463; G01N 2030/146; B01D 61/366; G01N 2001/4027; G01N 30/12

(57) ABSTRACT

The present invention relates to an evaporative membrane concentration device adapted to interface two liquid flow processes, such as two low or high resolution separation techniques or a low or high resolution separation technique and a liquid flow detection technique. For example, the two liquid flow processes may be a liquid chromatography technique and a liquid flow detection technique or a multi-dimensional separation technique, for example, two dimensional liquid chromatography (LC×LC) or solvent extraction, such as liquid-liquid extraction or solid phase extraction, with a liquid chromatography technique (LLE or SPE-LC). Methods of using the device and separation and/or chromatographic methods using the device are also described.

### FIELD OF THE INVENTION

The present invention relates to an evaporative membrane concentration device adapted to interface two liquid flow processes, such as two low or high resolution separation techniques or a low or high resolution separation technique and a liquid flow detection technique. For example, the two liquid flow processes may be a liquid chromatography technique and a liquid flow detection technique or a multi-dimensional separation technique, for example, two dimensional liquid chromatography (LC×LC) or solvent extraction, such as liquid-liquid extraction or solid phase extraction, with a liquid chromatography technique (LLE or SPE-LC). Methods of using the device and separation and/or chromatographic methods using the device are also described.

### BACKGROUND OF THE INVENTION

The complexity of biological and environmental samples poses a number of challenges for separation techniques, especially traditional one-dimensional separation techniques. Samples that contain more components than the peak capacity of a one dimension separation system are difficult to separate. Separation of the components of a complex sample having more components than the peak capacity of a one-dimensional separation technique may be separated using a multi-dimensional separation technique.

Two dimensional liquid chromatography (LC×LC) is referred to as comprehensive when the totality of the eluent from the first dimension separation (¹D) is transferred in fractions into a second dimension separation (²D). This technique commonly requires the use of a switching valve and two identical loops, one loop acting as an injection loop for the second dimension and the other loop acting as a collection loop at the outlet of the first dimension column. This technique is called passive modulation.

There are a number of limitations to passive modulation:
i) Each peak of the first dimension should be sampled at least three times by the second dimension to avoid remixing of separated compounds and loss of two-dimensional resolution.
ii) The smallest possible volume is required for injection onto the second dimension column to minimize band broadening and band distortion.
iii) A one-dimensional mobile phase with a higher elution strength than the two dimensional mobile phase should be avoided as this will worsen band broadening and band distortion.
iv) The large number of fast and large pressure pulses when the interface valve switches reduces the lifetime of the ²D column.
v) Dilution of analytes occurs through consecutive separation, collection and transfer of fractions and this hinders the detection of low abundance analytes.

To address these limitations, there must be careful selection of chromatographic columns and separation conditions. For example, optimal results may be obtained using micro/nano flow rates and narrow columns in ¹D and larger diameter columns in ²D.

In the alternative to passive modulation, active modulation may be used to minimize some of these issues. In active modulation, the volume, concentration and/or solvent (mobile phase) of the fractions from the ¹D column are modified before injection into the ²D column. In some cases it is possible to reduce the volume of the collected fractions without analyte loss such that ²D band broadening is not significant.

The most common form of active modulation in LC×LC is stationary-phase-assisted modulation where analytes are focused by being trapped in a packed loop interface and then subsequently released. However, the efficiency of this method may slowly decrease during analysis due to lack of trap column re-equilibration in between each fraction. Mismatch between trap separation columns and solvent systems must be avoided. When counter gradients are used to maintain constant solvent composition and lower elution strength, further dilution of analytes occurs in addition to intrinsic dilution that occurs with multi-dimensional chromatography systems. Similarly flow splitting also reduces the amount of low abundance analytes making them difficult to detect.

Another active modulation approach is thermal modulation. Analytes are retained on a highly retentive porous graphitic carbon packed column positioned between the ¹D and ²D columns. The analytes are remobilized by applying temperature ramps.

In-loop direct evaporation was introduced as a thermal modulation technique in an attempt to address solvent mismatch and loss of sensitivity between the ¹D and ²D columns. The system included heated collection loops connected to a vacuum. While this technique allows for instant solvent evaporation which assisted with solvent strength mismatched systems, the recovery of analytes depended on their boiling points. Low volatility analytes may be lost during this type of separation.

Solvent extraction is also a widely used separation technique used to selectively extract compounds of interest for analysis while leaving interfering matrix components behind. The solvents have to be chosen carefully to maximize extraction and avoid detrimental issues such as emulsion formation or miscibility. However, when chromatographic techniques are subsequently used, solvents also have a critical impact on chromatographic parameters such as retention, band spread, and peak shape. In some occasions, the organic solvent extract can be directly used for the chromatographic analysis, but it is rare for commonly used reverse phase liquid chromatography (RPLC). In such cases the solvent is dried down completely or evaporated partially, to be reconstituted in the desired volume and solvent at a later time. Previously, automation of liquid-liquid extraction and solid-phase extraction (SPE) has been reported, including extract evaporation, using an autosampler or the 96-well format to mimic traditionally manual operations. Online SPE goes beyond automation to integrate extraction in the analysis procedure, and it allows for fast, simple, and reproducible sample preparation minimizing human error. Such integration is more complicated when extract dry down is required in SPE or implementing liquid-liquid extraction. Most steps of liquid-liquid extraction (LLE) are performed manually and in particular removal of solvent by evaporation under nitrogen current can be very time consuming.

On-line evaporative concentrators for concentration of continuously flowing fluids are known. Solvent is removed by evaporation through a gas permeable hydrophobic membrane and exponential concentration factors could be achieved with application of temperature. However, the presence of changing amounts of organic solvent and the high precision temperature requirements pose a challenge in post-gradient LC separations. It is therefore difficult to maintain a constant solvent for injection into the ²D column. Furthermore, evaporation and sample reconstitution in a desired solvent mixture can be difficult in LLE or SPE-LC multi-dimensional processes.

The present invention is predicated at least in part on the discovery that an integrated feedback system may allow controlled temperature such that evaporation is controlled and therefore output flow is constant. The present invention may address one or more of the problems associated with comprehensive multi-dimensional chromatography or separation as set out above.

### SUMMARY OF THE INVENTION

In a first aspect of the invention, there is provided an evaporative membrane modulation device comprising:
i) an evaporative membrane concentration module comprising a heating element;
ii) a means of measuring output flow rate from the module; and
iii) a controller operably connected to the means of measuring flow rate and operably connected to the heating element;
wherein the controller adjusts the intensity of the heating element such that the output flow rate from the module is a desired output flow rate.

In other aspect of the present invention, there is provided a method of concentrating analytes and/or altering solvent mixture of an analyte composition comprising
i) flowing a liquid sample stream comprising an analyte composition and one or more solvents into an evaporative membrane concentration module comprising a heating element;
ii) measuring the output flow rate from the module;
iii) controlling the intensity of the heating element to evaporate solvent from the analyte composition and provide a desired output flow rate from the module.

In a further aspect of the present invention, there is provided a method of interfacing a first liquid flow process and a second liquid flow process, the first and second liquid flow processes having incompatibility in liquid phase composition or flow rate comprising placing an evaporative membrane modulation device described above between the first and the second liquid flow process.

In yet another aspect of the invention, there is provided a method of multi-dimensional liquid chromatography comprising interfacing an evaporative membrane modulation device described above between a first chromatographic separation and a second chromatographic separation.

In a further aspect of the invention, there is provided a multi-dimensional chromatographic instrument comprising at least one evaporative membrane modulation device described above.

### BRIEF DESCRIPTION OF THE FIGURES

FIG. 1A is an exploded view of an evaporative membrane concentration module. FIG. 1B is a view of an evaporative membrane concentration module assembled.

FIG. 2 is a diagram of an LC×LC system with an evaporative interface including the control unit. Chromatograph a) shows a trace of the HPLC separation of gallic acid, 4-hydroxybenzoic acid, syringic acid and vanillic acid from ¹D separation before evaporation. Chromatograph b) shows a trace of the HPLC separation of gallic acid, 4-hydroxybenzoic acid, syringic acid and vanillic acid from ¹D separation after evaporation. The LC×LC plot shows separation of the four compounds after the ²D separation.

FIG. 3 is a representation of flow rate monitoring at increasing aperture of the gas inlet valve under constant heating.

FIG. 4 provides representations of interface monitoring showing (A) flow measurements (black) and set point (dashed), (B) voltage applied to the heating elements and (C) the ¹D gradient applied over the experiment.

FIG. 5 provides ²D chromatograms of normal (A) and evaporative (B) interfacing and a cross-peak shape study.

FIG. 6 is a diagram of the evaporative membrane modulation device suitable to place between an extraction separation technique and a liquid chromatography technique. The Figure shows the positioning of a capacitively couple contactless conductivity detection system (C⁴D, 31) to measure eluent conductivity (σ).

FIG. 7 is a diagram the evaporative membrane modulation device suitable to place between an extraction separation technique and a liquid chromatography technique.

FIG. 8 provides chromatograms that compare direct injection of the extraction sample for HPLC analysis of chloramphenicol samples with the samples subjected to evaporative injection.

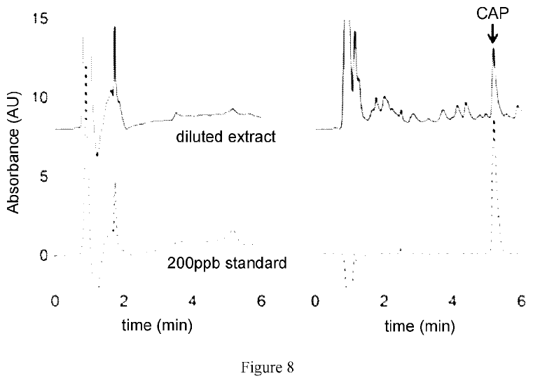

### DETAILED DESCRIPTION OF THE INVENTION

### Definitions

In the claims and in the description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

The articles “a” and “an” are used herein to refer to one or to more than one (i.e. to at least one) of the grammatical object of the article. By way of example, “an element” means one element or more than one element.

As used herein, the term “about” refers to a quantity, level, value, dimension, size, or amount that varies by as much as 30%, 25%, 20%, 15% or 10% to a reference quantity, level, value, dimension, size, or amount.

### Evaporative Membrane Module Device

The present invention provides an evaporative membrane modulation device comprising:
i) an evaporative membrane concentration module comprising a heating element;
ii) a means of measuring output flow rate from the module; and
iii) a controller operably connected to the means of measuring flow rate and operably connected to the heating element;
wherein the controller adjusts the intensity of the heating element such that the output flow rate from the module is a desired output flow rate.

### The Evaporative Membrane Module

The evaporative membrane module comprises a heating element suitable for heating at least a portion of the evaporative membrane module. In some embodiments, the heating element is situated to heat the liquid sample flow of an analyte containing sample within the evaporative membrane module. In some embodiments, the heating element is situated to heat the entire evaporative membrane module. In yet other embodiments, the heating element is situated to heat both the liquid sample flow of an analyte containing sample and the evaporative membrane module.

In some embodiments, the heating element is one or more light emitting diodes (LEDs), a thermoelectric heating/cooling element, a resistive heating element or a microwave heating element. In particular embodiments, the heating element is one or more LEDs and especially one or more infrared LEDs, such as LEDs emitting infrared light in the range of 700 nm to 10,000 nm, especially 1000 nm to 8000 nm, more especially 2000 nm to 5000 nm. On some embodiments, the infrared LED emits light at about 3000 nm.

In some embodiments, one LED is used as the heating element. In other embodiments, more than one LED is used. In some embodiments, 2, 3, 4, 5, 6, 7, or 8 LEDs are used. In a particular embodiment, 4 LEDs are used as the heating element.

Typically, the evaporative membrane concentration module further comprises a housing that encases the components of the module. In some embodiments, the housing is made of metal that is capable of withstanding reduced pressure without deformation. In particular, the housing may be made from stainless steel, aluminium, titanium and the like, especially stainless steel. In some embodiments, the housing is formed in two parts that may be fixed to one another, for example, by screws or clamps. In some embodiments, the means of fixing the two parts of the housing together is located evenly around the outer edge of the combined housing. For example, 2, 3, 4, 5 or 6 screws may be located around the outer edge of the housing, especially 4 screws. In some embodiments, there is a centrally located means of fixing the two parts of the housing together, for example, a centrally located screw. In yet other embodiments, there is both centrally located and peripherally located means of fixing the two parts of the housing together, for example, one centrally located screw and two, three or four screws located at the outer edge of the housing. A two part housing allows access to the components of the module described above for replacement or cleaning.

In some embodiments, the housing is also designed to house the heating element. In particular embodiments, the housing is designed to house the heating element in close proximity to the liquid sample flow channel to allow heating of the liquid sample within the flow channel.

Typically, the evaporative membrane concentration module further comprises a liquid sample flow channel engraved in a layer of material that fits within the housing. The liquid sample flow channel is connected to a sample inlet and a sample outlet, both inlet and outlet being located in the housing. In particular embodiments, the liquid sample flow channel is located adjacent to the housing, particularly the part of the housing containing the heating element.

The layer of material in which the liquid sample flow channel is etched may be made of any suitable material but is preferably made of a material able to transmit heat to the liquid sample and which is stable to the solvents to which it may be exposed. In some embodiments, the disc also allows at least partial visualization of the liquid sample flow channel and therefore is opaque, semi-opaque, semi-transparent or transparent.

In some embodiments, the layer of material in which the liquid sample flow channel is etched is a polymeric material. Suitable polymers include, but are not limited to, polyetherimide, cyclic olefin copolymers, polymethylmethacrylate, polycarbonate, polyester, polyethylene, polypropylene, polyvinyl chloride, polyethylene terephthalate, polytetrafluoroethylene, polyether sulfone, polybenzimidazole, polyacrylate, polylactic acid, polyetherether ketone, polyphenylene oxide, polyphenylene sulfide, polystyrene and polyurethane polymers. In a particular embodiment, the polymer is a polyetherimide polymer. In some embodiments, after machining to form the channel, the polymeric material is polished, for example, with aluminium oxide particles and/or vapour polishing with, for example, dichloromethane, to improve transparency.

The layer of material in which the liquid sample flow channel is etched is as thin as possible to improve transparency to infrared radiation. Typically, the thickness of the layer is in the range of 0.1 to 5 mm, especially 0.1 to 3 mm. In some embodiments, the thickness of the material is about 1.5 mm. In other embodiments, the thickness may be about 300 μm. The thickness of the material in which the liquid sample flow channel is etched may depend on the manufacturing method used to prepare the layer and the etched channel. The dimensions of the liquid sample flow channel will depend on the size and thickness of the layer into which it is etched and the volume and rate of flow of the liquid sample being treated. Typically, the channel is 150 μm to 300 μm wide, especially 200 μm to 250 μm wide and 150 μm to 300 μm deep, especially 200 μm to 250 μm deep. However, the dimensions of the channel may be larger, for example 300 μm to 50 mm or 300 μm to 1 mm or 300 μm to 500 μm wide or depending on the thickness of the layer, 300 μm to 750 μm or 300 μm to 500 μm deep, or smaller, for example 10 μm to 150 μm or 50 μm to 150 μm or 100 μm to 150 μm wide and 10 μm to 150 μm or 50 μm to 150 μm or 100 μm to 150 μm deep. The length of the channel will depend upon the exposure to the heating element that is desired and also on the flow rate of the liquid passing through the channel. A longer channel may be required for a larger flow rate. For example, the channel may extend across the layer from the inlet to the outlet, the channel may form a loop or series of loops in the layer that extend from the inlet to the outlet and passing under the heating element, or the channel may extend from the inlet to the outlet and include one or more serpentine features that are located under the heating element. Typically, the channel will be 500 μm to 1000 μm in length, for example, about 750 μm in length.

In some embodiments, the geometry of the channel varies, for example, the channel may be wide and deep where the mobile phase enters the evaporative membrane concentration device and may decrease in width and depth as evaporation occurs to provide a thin, shallow channel where the mobile phase exits the evaporative membrane concentration device.

The evaporative membrane concentration device further comprises a gas channel. The gas channel may be formed by one or more layers that are housed in the housing. The layer(s) that form the gas channel are made of material able to withstand vacuum. Suitably, the one or more layers that form the gas channel are made of a metal selected from stainless steel, aluminium, titanium and the like, especially from stainless steel.

The gas channel is connected to a gas inlet and a gas outlet. The gas inlet and gas outlet are located in the housing. The flow of gas through the gas channel may be controlled by the size of the aperture of the inlet and by the extent of negative pressure applied by the vacuum pump attached to the gas outlet. In some embodiments, the size of the aperture is controlled by a graded valve, for example a screw valve.

In some embodiments, the one or more layers are made from stainless steel. In some embodiments, the gas channel comprises a single layer. In other embodiments, the gas channel comprises more than one layer, for example 2, 3, 4, 5, 6, 7, or 8 layers, especially about 4 layers. Each layer in the gas channel is between 200 and 300 μm thick, especially about 230 to 270 μm thick, more especially about 250 μm thick. Each of the one or more layers being cut through to form a channel that passes through the one or more layers. Typically the gas channel cut through the one or more layers is about 150 to 350 μm wide, especially about 200 to 300 μm wide, more especially about 250 μm wide.

The evaporative membrane concentration module further comprises a vapour permeable membrane, especially a hydrophobic membrane that is located between and separates the liquid sample flow channel and the gas channel. The hydrophobic membrane may be made from any suitable porous hydrophobic material, such as polymeric materials or ceramic materials. In some embodiments, the hydrophobic membrane is made from a polymeric material, typically having a pore size in the range of 0.1 and 5 μm, especially 0.1 and 3 μm, for example, about 0.2 μm. Suitable hydrophobic polymeric materials include, but are not limited to polytetrafluoroethylene (PTFE), polypropylene (PP), polystyrene (PS), polyvinylidene fluoride (PVDF) and other hydrophobic polymers or hydrophobically coated polymers.

The evaporative membrane concentration module may be any shape and is typically shaped to fit in a multi-dimensional chromatography instrument. For example, the device may be circular, where each of the layers forms a circular disc within the housing, or the device may be square, where each of the layers forms a square disc within the housing. Other suitable shapes include triangular, pentagonal, hexagonal, heptagonal, octagonal and the like.

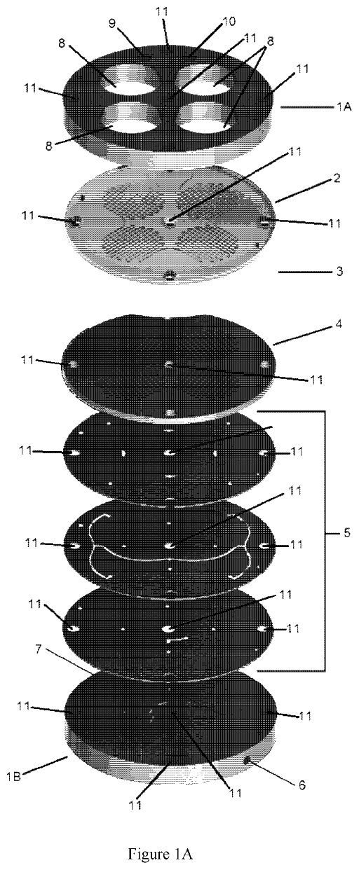

A preferred embodiment of the evaporative membrane concentration module without the heating element is shown in the exploded view in FIG. 1A. The housing 1 forms the bottom 1B and top 1A of the module. The top housing 1A includes four holes 8 positioned directly over the disc containing the liquid channel 2 into which a four infrared LED heating element may be fitted. The liquid channel is etched into the underside of the disc 2. The hydrophobic membrane 3 is sandwiched between the disc containing the liquid channel 2 and the disc containing the gas contact channel 4 and the gas distribution channels are formed by three further discs 5. The bottom housing 1B includes a gas inlet 7 connected to a gas supply by a valve and a gas outlet 6 connected to a vacuum pump. The top housing 1A has a liquid sample inlet 9 and a liquid sample outlet 10.

In use, the liquid channel disc 2, hydrophobic membrane 3 and gas channel discs 4 and 5 are sealed using the top 1A and bottom housing 1B which are held together with five screws 12, one centrally located and four placed evenly around the outer edge of the device, placed through all layers and holes 11 and secured. The assembled device is shown in FIG. 1B.

### Control of Evaporative Membrane Concentration Module

In order to obtain a constant flow leaving the evaporative membrane concentration module, a proportional, integral, derivative control system was used. The control system measures the flow rate of liquid phase at any time after the liquid phase exits the evaporative module. For example, the flow rate may be measured at the exit from the evaporative module or at any point after exit from the evaporative module and before entry into the second dimension of separation. The control system measures the flow rate and adjusts the intensity of the heating element in the evaporative module in response to the flow rate measured.

The flow meter may be any flow meter capable of measuring flow rates of from 0 to 4.0 mL min⁻¹ accurately, preferably with an accuracy in the range of about 0 to 10%, especially 0 to 5%, more especially less than 1%. In some embodiments, the flow rate will be small, 0.1 to 20 μL min⁻¹. In other embodiments, the flow rate may be larger, for example, 0.1 to 2 mL min⁻¹. Examples of suitable flow meters include calorimetric flow meters, turbine flow meters, vortex flow meters, electromagnetic flow meters, ultrasonic Doppler flow meters, positive displacement flow meter and mass flow meters. In a particular embodiment, the flow meter is a calorimetric flow meter.

In embodiments where the flow meter is sensitive to solvent or changes in solvent, a water reservoir may be placed at the inlet of the flow meter so that only water flows through the meter during measurement. In some embodiments, the water reservoir may be in the form of a coil.

The flow meter is operably connected to a microcontroller that has been provided with information relating to the desired flow rate. The microcontroller is any device capable of measuring the difference between the desired flow rate and the measured flow rate and regulating the power supply to the heating element such that the evaporation of solvent is controlled to provide or maintain the desired flow rate. In some embodiments microcontroller controls the power supply to the heating element through an n-channel metal-oxide-semiconductor field-effect transistor (MOSFET) containing an excess of free electrons. In other embodiments, the microcontroller may be a digital potentiometer. The regulation of the power supply to the heating element regulates the intensity of the heat provided by the heating element and thereby regulates the amount of solvent evaporation that occurs in the evaporation module.

Optionally, if it is desirable to monitor the solvent gradient profile of the solvent leaving the evaporative membrane concentration module (eluent), eluent conductivity (σ) may be monitored. Eluent conductivity may be monitored by, for example, capacitively coupled contactless conductivity detection (C⁴D, Zemann et al, Anal. Chem. 70, 1998, 563-567, doi: 10.1021/ac9707592).

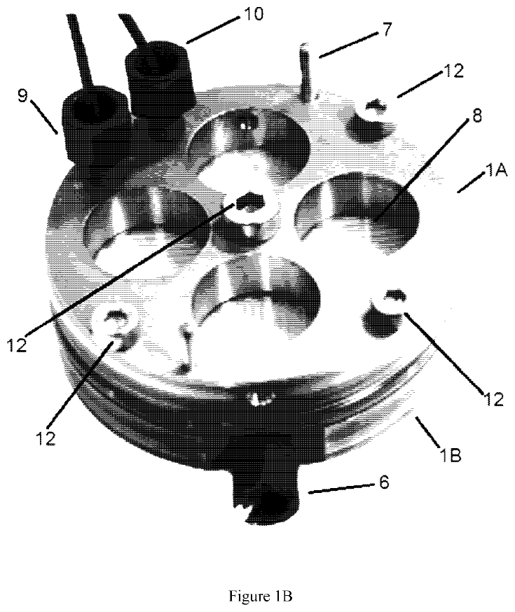

An exemplary control module placed between two liquid chromatography columns is shown in FIG. 2. The evaporation module 20 is placed in-line between the outlet 21 of the ¹D column 22 and the fraction collection valve 23. The fractions of the sample are collected in the fraction collection loop 24. The outlet of the fraction collection loop 24 is connected to the flow meter 25. A water reservoir 26 is placed between the outlet of the fraction collection loop 24 and the flow meter 25. The flow rate of the solvent exiting the evaporation module is measured while the fraction is collecting in the fraction collection loop 24 and while the fraction collection valve 23 is open. When the fraction is collected the switch 26 is switched to allow the fraction of sample and solvent to flow from the fraction collection loop 24 into the ²D injection loop 27, from which it is loaded onto the ²D column 28. After delivery of the fraction to the ²D injection loop 27, the switch switches back to open the fraction collection valve 23 to collect the next fraction and flow measurement resumes.

The flow meter 25 is connected to a microcontroller 29 which assesses the flow rate measurement against a desired flow rate and adjusts the power supply to the heating element 30 which regulates the level of evaporation of solvent in the evaporation module 20.

If the measured flow rate exceeds the desired flow rate, the microcontroller increases the power supply to the heating element resulting in an increase in heat intensity and an increase in evaporation of solvent. If the measured flow rate is less than the desired flow rate, the microcontroller decreases the power to the heating element resulting in reduced heat intensity and a reduction in evaporation of solvent. If the measured flow rate is the same as the desired flow rate, the microcontroller maintains the power supply to ensure constant evaporation at the same rate. The desired flow rate at the output of the evaporative module will depend on the incoming flow rate and the type of separation occurring. For example, in one embodiment, the flow rate entering the evaporative module may be 70 to 100 μL min⁻¹ and the desired flow rate exiting the evaporative module may be 7 to 10 μL min⁻¹. However, higher flow rates such as 1 mL min⁻¹ may be used in the first separation (¹D) and the desired output may be in the range of 100 to 500 μL min⁻¹.

In this manner, the concentration of analytes leaving the ¹D column or introduced from a LLE or SPE process are concentrated by the reduction of mobile phase solvent volume. Furthermore, if the liquid flow leaving the ¹D column or introduced from a LLE process is a mobile phase which is a mixture of solvents, with a steady state mixture or a gradient mixture of solvents, the evaporation of one solvent may occur preferentially depending on boiling point and volatility of each solvent in the mixture. The mobile phase solvent mixture may be altered by removal of one solvent or altering the ratio of the mixture of solvents.

In another aspect of the invention, there is provided a method of concentrating analytes and/or altering solvent mixture of an analyte composition comprising:
i) flowing a liquid sample stream comprising an analyte composition and one or more solvents into an evaporative membrane concentration module comprising a heating element;
ii) measuring the output flow rate from the module;
iii) controlling the intensity of the heating element to evaporate solvent from the analyte composition and provide a desired output flow rate from the module.

### Methods of Use

The evaporative membrane concentration modulation device of the invention is suitable for use to interface two techniques that have incompatibility in liquid mobile phase or in flow rate. For example, the evaporative membrane concentration modulation device may be suitable for use in multi-dimensional chromatography and/or extraction methods, where the device is placed between two separation processes or in single- or multi-dimensional chromatography techniques where the device is placed between a separation process and a detection device or in combinations of extraction and chromatography where the device is placed between an extraction process and a chromatography process (single or multi-dimensional). More than one device may be used in multi-dimensional chromatography system or extraction-chromatographic system or chromatographic-detection system.

In yet another aspect of the invention there is provided a method of interfacing a first liquid flow process and a second liquid flow process, the first and second liquid flow processes having incompatibility in liquid phase composition or flow rate comprising placing an evaporative membrane modulation device according to the invention between the first and the second liquid flow process.

In some embodiments, the first liquid flow process is selected from an extraction process and a chromatographic process. In some embodiments, the second liquid flow process is selected from a chromatographic process and a detection process. In particular embodiments, the first liquid flow process and the second liquid flow process are both chromatographic processes and therefore the method relates to a method of interfacing two chromatographic processes in a multi-dimensional chromatographic process.

In a particular embodiment, there is provided a method of multi-dimensional liquid chromatography comprising interfacing an evaporative membrane modulation device according to the invention between a first chromatographic separation and a second chromatographic separation.

The multi-dimensional chromatography method may be multiple combinations of liquid chromatography techniques such as high performance liquid chromatography (HPLC), reverse phase liquid chromatography (RPLC), ion exchange chromatography (IEC), size exclusion chromatography (SEC), normal phase chromatography (NP), hydrophilic interaction chromatography (HILIC), argentation chromatography (AR) or liquid chromatography under critical conditions (LCCC).

In some embodiments, the multi-dimensional chromatography is two dimensional (²D) liquid chromatography. However, further dimensions of chromatography may also be used. For example, the multi-dimensional chromatography may be three dimensional such as LC×LC×LC or LC×LC×GC or four dimensional such as LC×LC×LC×LC.

The evaporative membrane concentration modulation device may be placed between the first separation column and the second separation column of a two dimensional liquid chromatography instrument. Where more than two dimensions are used in the chromatography method the device may be placed between one or more of the pairs of columns, or in some embodiments, each pair of separation columns. For example, in a three dimensional chromatography method, the device may be placed between the first separation column and the second separation column, between the second separation column and the third separation column or between both the first and second separation columns and the second and third separation columns.

In multi-dimensional chromatography methods, the first separation method differs from the second separation method and the first and second separation methods differ from subsequent methods. In this manner analytes in the sample to be separated that are poorly resolved in the first method are resolved in the second or subsequent methods.

The separation methods in a multi-dimensional chromatography method may differ, for example, by column stationary phase, column size and diameter, by solvent, solvent mixture of solvent mixture gradient or combination of any of these.

In some embodiments, the multi-dimensional chromatography method is a two dimensional chromatography method selected from RP×RP, RP×NP, NP×RP, HILIC×RP, SEC×RP, IEC×RP, HILIC×HILIC, AC×RP, SEC×NP, LCCC×RP or SEC×IEC, especially RP×RP, NP×RP or HILIC×RP.

In some embodiments, the first and second columns have a stationary phase independently selected from a C18, C8, phenyl, amide, NH₂, anion exchange, cation exchange, ion exclusion or silica, especially C18, NH₂ or silica.

In some embodiments, the mobile phase solvent or solvent mixture used in the chromatography method is constant. In other embodiments, the mobile phase solvent is a mixture that is supplied as a gradient, where the solvent mixture varies over time.

In some embodiments the mobile phase solvent mixture comprises one or more of water, acetonitrile, methanol, ethylacetate and buffering solutions such as ammonium acetate or formic acid.

In some embodiments, the diameter of the first column is smaller than the diameter of the second column. In other embodiments, the second column is smaller than the first column. In yet other embodiments, the first column and second column have the same diameter.

In some embodiments, the flow rate of the first separation is at a lower rate than the flow rate of the second separation.

In some embodiments, the evaporation membrane module device interfaces an extraction process with a chromatographic process. The extraction process may be a solid phase extraction process or a liquid phase extraction process, especially a solid phase extraction process. The extraction process may be used to remove impurities or analytes with specific properties. The extraction process may rely on hydrophobic intereactions, hydrophilic interactions, ion exchange, van der Waals or dispersion forces, hydrogen bonding, pi-pi interactions, dipole-dipole interactions or dipole-induced dipole interactions. For example, solid phase extraction may be used to remove highly polar, charged or highly hydrophobic impurities from a sample, such as a biological sample, before it is transferred to a separation process such as single or multidimensional liquid chromatography.

In some embodiments, the evaporation membrane module device interfaces a chromatographic process and a detection process. While this module may be used to interface a chromatographic process with any detection process, it is most useful where the detection process is sensitive to liquid phase flow rate, the identity of the liquid phase or variability in the liquid phase, for example with corona charged aerosol detection (CAD) or ion suppression conductivity (IC) detection.

Suitably, the evaporation membrane module device is part of a chromatographic instrument. In yet another aspect, there is provided multi-dimensional chromatographic instrument comprising at least one evaporative membrane modulation device according to the invention.

The chromatographic instrument may be a standard or commercially available chromatographic instrument having at least some of one or more solvent inlets, one or more solvent filters, one or more pumps, an injection valve, one or more pre-column filters, one or more columns, a detector, a waste reservoir, one or more collection loops and at least one switching valve. The switching valve may allow the mobile or liquid phase from the first column to enter the second column, optionally via a collection loop. The switching valve may be a 2 position switching valve and may have 2, 4 or 6 ports.

The invention will now be described with reference to the following Examples which illustrate some preferred aspects of the present invention. However, it is to be understood that the particularity of the following description of the invention is not to supersede the generality of the preceding description of the invention.

### EXAMPLES

### Example 1: Comparison of Separation of Standard Mixture Using LC×LC and LC×LC with Evaporative Membrane Modulation (LC^{EEM}×LC)

### Standard Sample Preparation

Gallic acid, 4-hydroxybenzoic acid, syringic acid and vanillic acid of analytical reagent grade were purchased from Sigma-Aldrich (St Louis Mo., USA). A solution for testing was prepared having 13 ppm gallic acid, 6.5 ppm 4-hydroxybenzoic acid, 7.3 ppm syringic acid and 15 ppm vanillic acid.

### Chromatography Apparatus, Solvents and Systems

All chromatographic separations were performed on a 1290 Infinity 2D-LC instrument from Agilent Technologies operated with two binary pumps, a 4-port duo switching valve for LC×LC interfacing and a UV detector (Santa Clara, Calif., USA). The instrument was powered by OpenLab software.

Formic acid 98% was obtained from Sigma-Aldrich (St Louis, Mo., USA). Solutions were prepared in water from a Milli-Q water plus system from Millipore (Bedford, Mass., USA). Acetic acid 100% (Merck KGaA, Darmstadt, Germany) and ammonia solution 28% (Univar, Seven Hills, NSW, Australia) were used to prepare ammonium acetate (pH 4.3) solution. HPLC grade methanol (VWS Chemicals, Fontenay-Sous-Bois, France) and HPLC grade acetonitrile (Unichrom, Taren Point, NSW, Australia) were used for mobile phase preparation.

¹D separation was performed using a Zorbax Eclipse Plus C18 2.1-50 mm column and 1.8 μm sized particles (Agilent, Santa Clara, Calif., USA). The mobile phase used was 0.1% formic acid in water (A) and methanol (B) at a flow rate of 50 μL min⁻¹. The gradient used increased from 10-30% MeOH in 22 minutes.

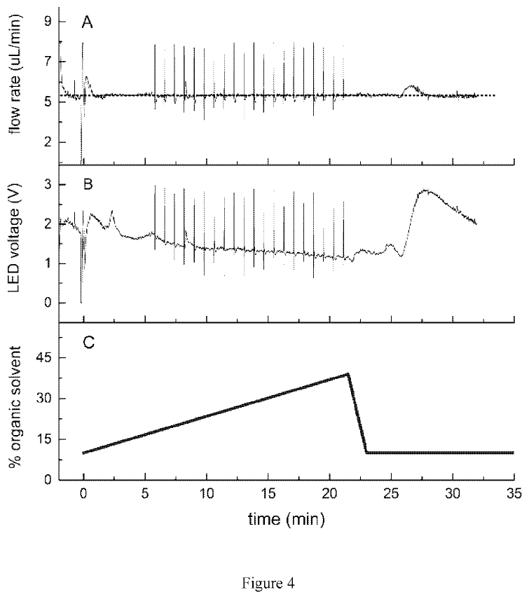

²D separation was performed using a Chromolith Performance NH₂ 4.6×10 mm column (Merck KGaA, Darmstadt, Germany). The mobile phase used was 20 mM ammonium acetate pH 4.3 in water (A) and acetonitrile (ACN) (B), at a flow rate of 4 mL min⁻¹. ²D separations were 0.8 min long with a 0.01 min modulation time. UV detection was performed at 254 nm. 0.8 min gradients in ²D separations increase from 13 to 16% ACN for the first 7 minutes, dropping then to an initial 6%. 0.8 min gradients increase then from 6% to 8% ACN until 6 to 10% ACN at 16 minutes. When the evaporative interface was used, the ²D separations were delayed by 5.5 minutes as shown in FIG. 5.

Single dimension peak capacity (ⁱn_{C}) was calculated using equation (1), while theoretical and effective LC×LC peak capacity (nC,2D and n*C,2D respectively) were calculated using equations 2 and 3 (Huang et al., J. Chromatogr. A, 2011, 1218(20), 2984-2994).

$$\begin{matrix}{}_{}^{i}{n}{}_{c}^{} = 1 + \frac{{}_{}^{t}{R}{}_{1}^{} last - {}_{}^{t}{R}{}_{1}^{} first}{\overline{W}} & ( 1 ) \\ {n}_{{C}_{1} 2 D} = {}_{}^{1}{n}{}_{c}^{} \times {}_{}^{2}{n}{}_{c}^{} & ( 2 ) \\ {n}_{{C}_{1} 2 D}^{*} = \frac{{}^{1} nc \times {}^{2} nc}{〈 β 〉} \times {f}_{coverage} & ( 3 )\end{matrix}$$

The use of the correction factor <β> has been extensively studied in order to take into account the undersampling (Davis et al., Anal. Chem., 2008, 80(21) 8122-8134; Dugo et al., J. Chromatogr. A, 2008, 1184(1-2), 353-368).

The coverage factor (f_{coverage}), extensively described by M. Gilar et al., can be used in equation 3 and used when considering the orthogonality of the separation (Rutan et al., J. Chromatogr. A, 2012, 1255, 267-276, Gilar et al. Anal. Chem. 2012, 84(20), 8722-8732).

One-dimensional HPLC separations were performed and the chromatograms recorded either before or after the evaporative interface for comparison, referred as ¹D and ¹D^{EEM}, respectively. Three sets of triplicates were acquired on different dates for both conditions. LC×LC separations were performed in triplicate on different dates with both a switching valve dual-loop interface and the evaporative membrane modulator. In the first case 50 μL loops were used to collect 48 μL fractions. When using the evaporative interface, initial 50 μL min⁻¹ input flow rate was reduced to 5.00 μL min⁻¹, evaporating 90% of the mobile phase. In this case, 5 μL loops were used to collect 4.8 μL fractions.

### The Evaporation Module

The evaporation module comprises a hydrophobic polytetrafluoroethylene PTFE unlaminated membrane with 0.2 μm pore size (Sterlitech Corp. Kent, Wash., USA) sandwiched between a liquid and a gas channel. The liquid channel was engraved in a 1.5 mm thick polyetherimide (PEI) disc (Quadrant Plastics, Lenzburg, Switzerland) using a Computerized Numerical Control (CNC) drill. The channel was 220±12 μm wide and 216±18 μm deep with a total length of 741.7 mm. After the channels were machined, the surface was polished using aluminium oxide particles and vapour polished with dichloromethane to increase transparency. The 250 μm wide air channel was laser cut in a 250 μm thick stainless steel disc and diffusion bonded to further discs to construct the gas inlet and outlet. The channels were sealed using a bottom and top metallic case held together with 4 screws sandwiching the discs and membrane in between. An exploded view of the device is presented in FIG. 1. The top of the housing has liquid inlet and outlet fittings as well as four large holes positioned directly over the liquid channel. These holes were designed to fit four pulsed infrared light emitting diodes (LEDs, 3000 nm wavelength, Helioworks Inc., Santa Rosa, Calif., USA) used as heat source for evaporation of the liquid. The LEDs provide two heating mechanisms both as a heat source that slowly heats the module, and direct heating of the water in the liquid channel by the 3000 nm infrared radiation that travels across the polyetherimide disc providing very fast response. The outlet of the gas/vacuum channel is connected to a miniature vacuum pump (model 1420VP BLDC, Gardner Denver Thomas; Fürstenfeldbruck, Germany) powered at constant voltage while the gas inlet can be regulated using an adjustable graded valve to provide reduced pressure and a sweeping air-flow. The optimum aperture was determined by applying constant heating at a flow rate of 20 μL min⁻¹ with a closed inlet valve and subsequently opening the screw inlet valve at 0.1, 0.2 or 0.5 intervals for around a minute. The flow rate was monitored after the evaporation device and the aperture that achieved maximum flow reduction was set as optimum.

### Evaporative Membrane Modulator Operation

A schematic diagram of the modulator and its position and control for LC×LC is shown in FIG. 2. The evaporation module is connected on-line between the ¹D separation column and the fraction collection valve. Fractions are collected in a loop (24 in FIG. 2) with the outlet of this loop connected to a flow meter. Since temperature based flow meters are sensitive to the solvent and solute composition in the stream, a water reservoir coil was placed at the inlet of the flow meter so that only water flows through the meter during measurement. The flow rate was measured for the feedback loop, which regulated the power supply to the 4 IR LEDs. To power the LEDs, an external current limited power supply was used which was regulated by the microcontroller through an n-MOSFET. When the switching valve is switched after collection, the loop contents are injected into the ²D separation column. UV detection was performed after ²D separation.

### Development and Tuning of the Evaporative Interface

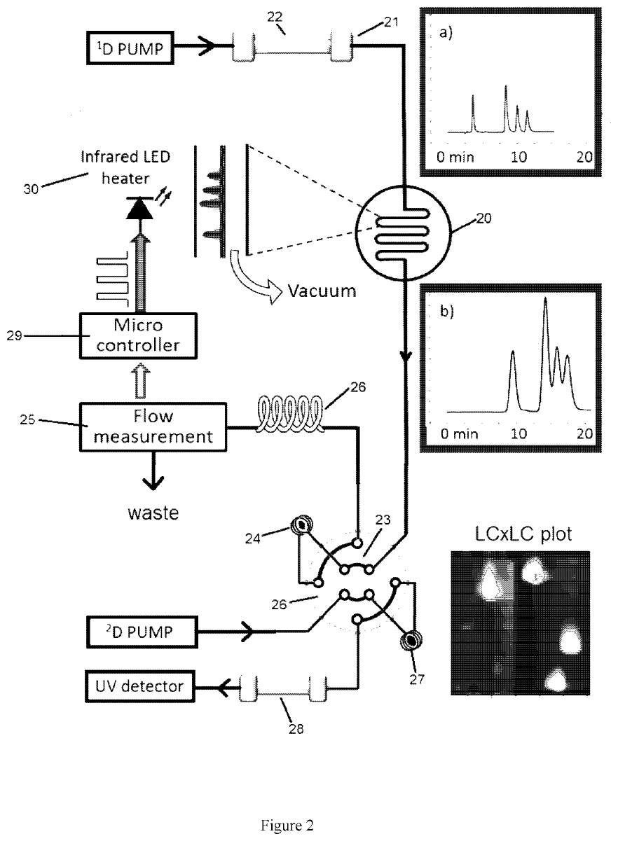

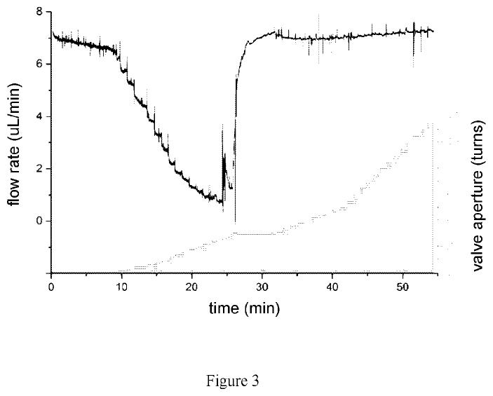

To assess and optimize the effectiveness of the evaporative interface and proportional-integral-derivative (PID) control system, flow measurements together with voltage output in the heating element were recorded during ¹D gradient experiments. PID parameters were optimized to provide minimum fluctuation in the output flow, and the gas inlet valve was adjusted to an optimum aperture where minimal temperature was required for maximum flow rate reduction. The gas inlet valve was a graded screw valve where when fully closed was allocated 0 then each full turn of the screw was allocated a consecutive whole number. The optimum aperture was that which achieved maximum flow reduction as shown in FIG. 3, determined to be 2.8 turns. At the optimal aperture size, the flow rate increased sharply up to the initial evaporation performance and remained constant even with a fully open gas inlet valve. Hence, the gas channel configuration featuring an air flow at a pressure lower than atmospheric showed better removal of the solvent vapours in the gas channel, and therefore lower heating needed. Subsequently, measured flow and the LED voltage applied during LC×LC separations were recorded, shown in FIG. 4, along with the ¹D gradient performed (FIG. 4C). It can be seen from FIG. 4A that the output flow rate was constant over the entire ¹D gradient and overlayed almost perfectly with the set flow rate of 5 μL min⁻¹ (FIG. 4A dashed). In order to do this, the voltage (FIG. 4B) decreased when the amount of organic solvent in the mobile phase increased and returned to initial voltage when the mobile phase returned to starting conditions. Regular pulses in both the flow rate measurements and LED voltage were recorded due to the pressure pulses originated in the switching valve once ²D separations are started. However, considering the fast response of the feedback loop the voltage and flow rapidly returned to the set point and has minimal impact in the performance of the evaporating interface.

¹D^{EMM}—Evaluation Before 2D Separation

When one-dimensional HPLC separations were performed, an average delay of around 5.5 minutes in peak detection was observed when the evaporative interface was used. FIG. 2 a) and b) show chromatograms of the separation of gallic, 4-hydroxybenzoic, syringic and vanillic acids, in the same time and absorbance scale. Retention time in between replicates performed on the same day show relative standard deviations (RSD) of up to 0.72% without the modulator and 0.85% after going through the evaporative membrane modulator. RSD for all the 9 replicates—carried out in sets of 3 in 3 different days—is up to 0.99% without the modulator and varying between 1.9-4.2% with the evaporative interface. This increased variability is due to the principle of calorimetric flow sensing since it detects the thermal profile due to fluid flow around a heater. Therefore, proper thermal flow sensor response is dependent upon a constant fluid temperature and a minimal inaccuracy due to temperature drift is observed. To avoid this, the temperature can be controlled in the flow measurement station (Kuo et al., Micromachines, 2012, 3 (3), 550-573).

All 4 analytes were quantified in triplicate before and after the evaporative interface. Peak height increase was found to be significantly lower for gallic acid (1.7 fold) than other analytes (2.5-2.7 fold). Peak widths measured in μL were used to estimate the volume of the analyte band, which decreased around 4 times, except for gallic acid which was only reduced by 2.6. To compare the peak areas with and without modulator, the time scale was converted to volume by multiplying by the flow rates of 5 and 50 μL min⁻¹, respectively. Recoveries were then calculated to be between 77 and 96%. Peak symmetry was greatly improved from 1.66±0.06 to 1.16±0.01.

Ideally, with a 100% recovery and no longitudinal diffusion, when reducing flow rate 10 times the peak band volume should decrease 10 times and the peak height increase by 10. The results show that the observed enhancement with the evaporative modulator is noticeably lower, most likely due to the fluid in the evaporator spending considerable time at elevated temperatures, which enhances longitudinal diffusion. This results in a decreased peak capacity in the first dimension from 13.6 to 5.7.

LC^{EMM}×LC separations were performed using the model mixture, with and without the evaporative modulator, with the chromatograms shown in FIG. 5. The evaporation module allowed each ¹D peak to be sampled between 3 and 4 times in the second dimension in contrast to the switching valve approach where each ¹D peak was only sampled 2-3 times. This improves quantitation capabilities since the ¹D peak is better represented in the 2D plot, while sensitivity is not impaired because analyte mass is preserved (i.e. ¹D flow splitting is avoided). To assess other improvements, the separation widths of peaks in the second dimension were compared with and without the evaporative modulator. Widths of the two biggest peak fractions were recorded in triplicate, and the average ²D peak width was found to be reduced between 6-22% at half maximum (PWHM) and 2-25% at the w10%. Consequently, ²n_{C} is enhanced by 10%. All individual values for various chromatographic parameters are shown in Table 1 for comparison.

TABLE 1
Individual chromatographic parameters of each individual analyte in passive and active modulation

| | LCxLC - passive modulation | | | | LC^{EEM}xLC - active modulation | | | |
|---|---|---|---|---|---|---|---|---|
| | | 4- | | | | 4- | | |
| | | hydroxy | | | | hydroxy | | |
| acids | gallic | benzoic | syringic | vanillic | gallic | benzoic | syringic | vanillic |
| Fraction volume (μL) | 48 | | | | 4.8 | | | |
| Collection loops volume | 50 | | | | 5 | | | |
| (μL) | | | | | | | | |
| ¹D peak symmetry | 1.580 ± | 1.692 ± | 1.681 ± | 1.688 ± | 1.15 ± | 1.168 ± | 1.170 ± | 1.146 ± |
| | 0.084 | 0.017 | 0.013 | 0.021 | 0.01 | 0.003 | 0.004 | 0.005 |
| ¹D peak height | 181.7 ± | 226.1 ± | 124.8 ± | 103.2 ± | 309 ± | 572 ± | 326 ± | 281 ± |
| | 5.2% | 2.0% | 1.9% | 1.8% | 11.3% | 9.4% | 8.8% | 7.0% |
| ¹D^{EEM} peak height increase | — | — | — | — | 1.70 | 2.53 | 2.61 | 2.72 |
| ¹D peak area | 139459 ± | 259028 ± | 148979 ± | 122740 ± | 89851 ± | 168952 ± | 102359 ± | 98601 ± |
| | 2.0% | 1.2% | 0.9% | 1.8% | 10.7% | 8.1% | 7.2% | 7.1% |
| ¹D^{EEM} recoveries (%) | — | — | — | — | 77.3 | 78.3 | 82.5 | 96.4 |
| ¹D peak width (min) | 0.414 ± | 0.656 ± | 0.696 ± | 0.6889 ± | 1.5865 ± | 1.6000 ± | 1.697 ± | 1.7978 ± |
| | 0.036 | 0.012 | 0.013 | 0.0051 | 0.0065 | 0.0000 | 0.010 | 0.0039 |
| ¹D peak width 4σ (μL) | 20.7 ± | 32.78 ± | 34.78 ± | 34.44 ± | 7.933 ± | 8.000 ± | 8.489 ± | 8.989 ± |
| | 1.8 | 0.59 | 0.67 | 0.25 | 0.032 | 0.0000 | 0.051 | 0.019 |
| ¹D^{EEM} peak volume | — | — | — | — | 2.61 ± | 4.10 ± | 4.10 ± | 3.83 ± |
| reduction | | | | | 0.23 | 0.07 | 0.10 | 0.02 |
| ²D peak base width (min) | 0.1138 ± | 0.0880 ± | 0.1019 ± | 0.1127 ± | 0.1068 ± | 0.081 ± | 0.079 ± | 0.100 ± |
| | 0.0052 | 0.0035 | 0.0132 | 0.0046 | 0.0073 | 0.014 | 0.010 | 0.015 |
| ²D peak width decrease (%) | — | — | — | — | 6.1 | 8.4 | 22.7 | 11.6 |

| | | |
|---|---|---|
| n_{C,1} | 13.6 | 5.7 |
| n_{C,2} | 6.6 | 7.5 |
| n_{C,2D} | 90.8 | 42.7 |
| n*_{C,2D} | 34.7 | 31.9 |

The theoretical peak capacity n_{C,2D} both with and without the evaporative modulator was calculated and was higher without, 91 compared to 43 with the EMM. However, when the peak broadening factor <β> is considered to take into account undersampling, without the modulator the corrected peak capacities n*_{C,2D} is 35 and 32 with the modulator. This suggests that with EMM the decrease in peak capacity in the first dimension (¹n_{C}) is compensated in the 2D system by an increase in the ²D peak capacity and better sampling of the ¹D peaks. In this study f_{coverage}=1 is considered for the purpose of comparison between LC×LC and LC^{EEM}×LC separations.

In addition, when using the evaporative interface there were remarkably less peak-slice to peak-slice retention ²D time differences. Using common switching valve modulation the retention time in the second dimension decreased by 3-4 s with each slice, while using EMM this decrease was reduced to 0.4 s. This phenomenon can be observed in the cross-peak shape study in FIG. 5 where the experimental ²D retention times were plotted overlaying the 2D peaks. Such achievement highlights a key benefit of solvent removal preserving the 2D separation performance. In a LC×LC system, it is a remarkable advantage for peak identification of complex samples where some analytes may be partially co-eluting.

### Example 2: LLE-HPLC Method

Chloramphenicol is an antibiotic used as a human therapeutic agent but banned from the food production chain due to genotoxicity concerns, therefore sensitive and reliable methods for its analysis are needed. Determination of antibiotics in food is not simple since samples of animal origin are generally complex matrices. LLE, either alone or followed by solid-phase extraction (SPE), is widely used for amphenicols analysis although procedures vary for each particular matrix. Ethyl acetate is the most commonly used LLE solvent for the extraction of amphenicols. Regarding separation techniques, the most widely used analytical methods for the analysis of chloramphenicol in food are gas chromatography and high performance liquid chromatography. However, since chloramphenicol (CAP) is a polar and is non-volatile molecule, derivatisation must be performed prior to GC analysis to form a stable volatile compound. High performance liquid chromatography (HPLC) is another widely used technique generally associated with mass spectrometry (MS). UV detection has also been reported but was not sensitive enough to provide limits of detection competitive with MS detection at low part-per-billion levels. Issues rising from solvent incompatibilities in in LLE-HPLC analysis have been addressed in a case-by-case basis, generally involving time-consuming offline steps.

### Materials and Methods

### Solvent Evaporator Operation

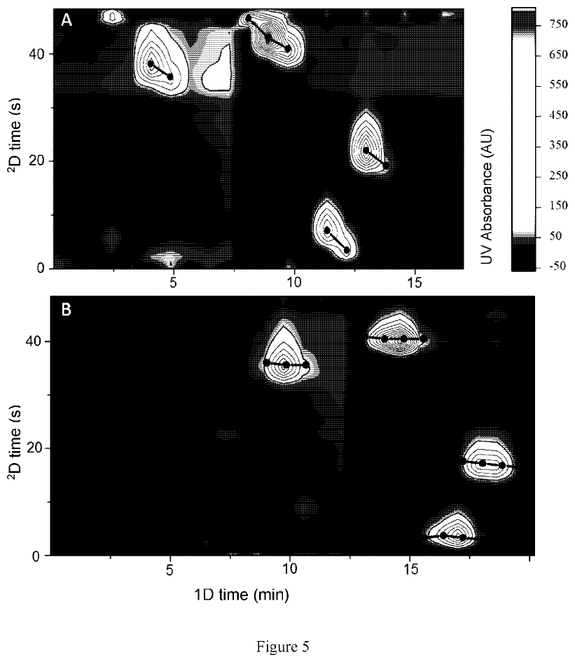

To implement an on-line solvent evaporator, it is necessary to precisely control temperature to ensure constant evaporation rate and therefore maintain constant flow rate despite the changing amounts of organic solvent. This was addressed by monitoring the evaporator outlet flow rate, using an interactive feedback control mechanism run by a microcontroller to adjust the intensity of a heating element such that the output flow matched the desired flow rate. A schematic representation of this mechanism is shown in FIG. 6. The difference between set flow rate and setpoint define the extent of evaporation, which we refer to in percentage of evaporation. The feedback control mechanism implemented was the extensively used PID, or proportional-integral-derivative control. Since temperature based flow meters are sensitive to solvent and solute composition in the stream, a water or IPA reservoir coil was placed at the inlet of the flow meter so that only the chosen solvent flows through the meter during measurement.

### Liquid-Liquid Extraction Methodology

Six standard solutions of CAP (10, 25, 50, 100, 200, 500, 1000 ppb) were prepared in a water/acetonitrile/ethyl acetate (W:ACN:EA) solution, in abundance (48:44:8). The standards were analyzed after an evaporative injection and used to obtain the calibration curve. Spiked samples at levels of 89.3, 177.0 and 348.4 ppb, as well as blank samples, were also prepared using milk fresh, full fat milk matrix. An aliquot of CAP standard was added to the milk aliquot and mixed before extraction to obtain spiked samples. Six different extraction conditions were tested including single and double step extraction methods. A first aliquot of extractant was added to the milk sample and vortex mixed for one minute. The mixture was centrifuged at 10000 rpm for 4 minutes using a Sigma 1-14K centrifuge. Both liquid phases were removed and the solid residue was subjected to a second extraction by firstly mixing with water aliquot before adding the extractant. After vortex mixing and centrifugation, liquid phases of both extractions were combined and kept in the refrigerator to maximize phase separation. Supernatant was then removed from the ependorff vial by suction using a syringe and needle. To perform the evaporative injection, extracts were reconstituted 1:4 by mixing with 40% acetonitrile solution. Six different extraction procedures were tested including four double step and two single step methods shown Table 2:

TABLE 2

| | | V sample | Vorg (μL) | Recovery |
|---|---|---|---|---|
| | Extraction | 348.4 ppb/ | ACN/EA | (%) ± SD |
| Conditions | step | V water (μL) | (6:4) | (n = 3) |
| 1 | 1 | 200 sample | 400 | 74.8 ± 0.37 |
| | 2 | 100 water | 200 | |
| 2 | 1 | 400 sample | 400 | 79.5 ± 1.20 |
| | 2 | 200 water | 200 | |
| 3 | 1 | 500 sample | 400 | 78.1 ± 4.27 |
| | 2 | 250 water | 200 | |
| 4 | 1 | 600 sample | 400 | 89.0 ± 1.63 |
| | 2 | 300 water | 200 | |
| 5 | 1 | 600 sample | 400 | 73.4 ± 3.35 |
| 6 | 1 | 800 sample | 400 | 79.6 ± 2.49 |

Analyses were performed by triplicate using spiked samples at a high concentration of 2.8 ppm as well as a blank sample. Recoveries were calculated using a calibration curve 50-1000 ppb and conditions with the highest recovery (extraction method 4) was chosen for further tests. Using extraction method 4, three different spiked samples at a lower range of CAP concentrations were tested by evaporative injection HPLC, using a calibration curve in the range 10-200 ppb.

### Separation Conditions

CAP was determined using an Agilent 1290 Infinity series HPLC with a Poroshell C₁₈ column 2.1×150 mm 4.7 μm performing an acetonitrile gradient from 18 to 30% in 5 minutes, then increasing to 95% ACN before equilibration. Both aqueous and organic phase contained 0.1% acetic acid and the column was kept at 30° C. Detection was performed with a UV detector at 270 nm. A 10-port valve was used to transfer reconstituted extract into the HPLC system and start the separation gradient controlled by Agilent 2DLC software.

### Evaporative Injection

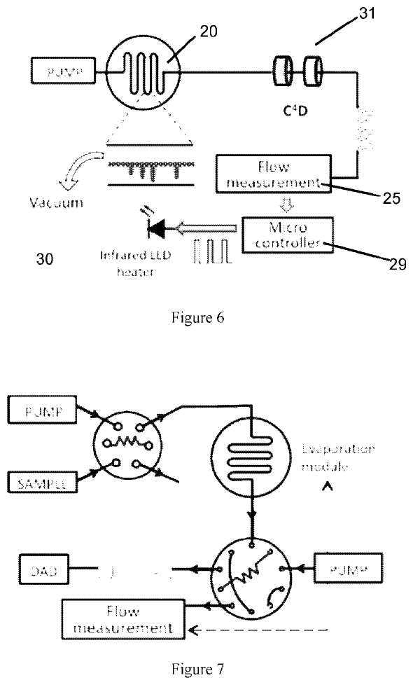

To avoid extract dry down and dissolution, an online solvent removal procedure with automated HPLC injection was developed. The extract was firstly diluted obtaining a single phase with some water content, and subsequently injected in the evaporative solvent remover. Water is the final sample solvent before HPLC injection. The injected volume was carried into the device at a constant flow rate using an HPLC pump, and it exited the device at a lower constant flow rate after solvent removal. When the sample exited the device in a changed solvent composition, it was directed to a collection loop in a switching valve that automatically switched at the injection time when all the reconstituted extract had filled the loop. The contents of the loop were then analyzed by HPLC, in this case using UV detection at 270 nm. For the purpose of this study the carrying phase was 55% ACN at a flow rate of 25 μL·min⁻¹, while evaporation setpoint was 10 μL·min⁻¹ to achieve evaporation of 60% of the flow. Injection and collection loops were 100 and 60 μL in volume, respectively. FIG. 7 shows a diagram of the device set up.

### Extraction and Reconstitution

Both acetonitrile and ethyl acetate have been reportedly used to extract chloramphenicol from milk. When using acetonitrile, samples should be frozen and/or vortexed at low temperatures to allow low temperature partitioning (LTP). Also, ethyl acetate alone was not used for extraction to facilitate sample reconstitution. When preparing the extract for evaporative solvent removal, water needs to be added to the extract to provide the final sample media, so using only ethyl acetate would make it difficult to obtain a single phase solution. Therefore, to obtain two separate phases in all studied extraction conditions but also a miscible diluted extract, phase diagrams of a ternary mixture containing water, acetonitrile and ethyl acetate (W/ACN/EA) were examined (Fujinaga et al., Anal. Methods, 4, 2012, 3884, doi: 10.1039/c2ay25867f). The composition of organic phase for extraction was chosen at acetonitrile/ethyl acetate (60:40). Extract dilution performed before evaporative solvent removal was 1:4 dilution in water/acetonitrile (60:40), obtaining a tertiary mixture W/ACN/EA at a composition of 48:44:8. Standards for HPLC-UV analysis were also prepared in this latest solvent composition. Evaporative injection was then performed with samples and standards as described previously and recoveries calculated for 4 different concentrations. As shown in Table 3, recovery was around 85% except for the lowest spiked sample, which was significantly greater since UV is not a reliable detection method for this analysis. Complete separation from matrix components cannot be ensured and therefore peak integration becomes difficult and erratic. Also, sensitivity can be improved greatly by using Mass Spectrometry.

TABLE 3

| | | Recovery |
|---|---|---|
| C_{CAP}-milk | C_{CAP}-diluted | (%) ± SD |
| (ppb) | extract (ppb) | (n = 3) |
| 89.3 | 30 | 95.1 ± 4.0 |
| 177.0 | 60 | 85.8 ± 1.6 |
| 348.4 | 120 | 85.3 ± 3.2 |
| 2805.2 | 960 | 89.0 ± 1.6 |

To prove the value of evaporative injection despite the necessary extract dilution standards and diluted extracts were analyzed directly by HPLC with a regular injection, resulting in total peak distortion. CAP sharp peak at 5.3 min disappeared as well as other separated components of the matrix, while a long split peak was eluted between 3.5 and 5.5 min. Chromatograms are shown in FIG. 7 in comparison with evaporative injection results. This distortion is likely due to the big volume of very strong organic solvents in the sample worsened by the presence of ethyl acetate, which can be immiscible at high pressures specially at the start of the gradient.

### Method LOD and LOQ

Although full validation was not undertaken, off-line LC-MS/MS analysis of the reconstituted extracts was performed to determine an indicative limit of detection (LOD) and limit of quantification (LOQ) of the described method. The standard deviation of the calibration curve residuals (σ) as well as the slope (S) were used for this purpose in the following equations: LOD=3*σ/S and LOD=10*σ/S. Collection and storage of reconstituted extracts opposed to on-line analysis is likely to have introduced error in the measurements and increased analysis dispersion. However, LOD was calculated at 0.088 ppb and LOQ 0.294 ppb, below the minimum required performance limit (MRPL) of 0.3 and 0.5 ppb in Europe and China, respectively. MRPL correspond to the minimum content that laboratories should be able to detect and confirm by a reference analytical method.

1. An evaporative membrane modulation device comprising:
i) an evaporative membrane concentration module comprising a heating element;
ii) a means of measuring output flow rate of a liquid sample from the module; and
iii) a controller operably connected to the means of measuring flow rate of the liquid sample and operably connected to the heating element;
wherein the controller adjusts the intensity of the heating element such that the output flow rate from the module is a desired output flow rate and wherein
the heating element is situated to heat the flow of liquid sample within the evaporative membrane concentration module.

2. (canceled)

3. The evaporative membrane device according to claim 1 wherein the heating element is selected from one or more light emitting diodes, a thermoelectric heating/cooling element, a resistive heating element or a microwave heating element.

4. (canceled)

5. The evaporative membrane device according to claim 1 further comprising a liquid flow channel connected to an inlet and an outlet.

6. The evaporative membrane device according to claim 5 wherein the liquid flow channel is etched in a polymeric material.

7. The evaporative membrane device according to claim 6 where the polymeric material is semi-transparent or transparent.

8. The evaporative membrane device according to claim 5 wherein the liquid flow channel is 150 to 300 μm wide and 150 to 300 μm deep.

9. The evaporative membrane device according to claim 1 further comprising a gas channel connected to a gas inlet and a gas outlet.

10. The evaporative membrane device according to claim 9 wherein the gas outlet is connected to a vacuum pump.

11. The evaporative membrane device according to claim 1 further comprising a vapour permeable membrane.

12. The evaporative membrane device according to claim 1 wherein means of measuring output flow rate of the liquid sample from the evaporative membrane concentration module is a flow meter.

13. The evaporative membrane device according to claim 12 wherein the flow meter is selected from a calorimetric flow meter, a turbine flow meter, a vortex flow meter, an electromagnetic flow meter, an ultrasonic Doppler flow meter, a positive displacement flow meter and a mass flow meter.

14. (canceled)

15. The evaporative membrane device according to claim 1 wherein the controller assesses the flow rate measurement provided by the flow meter against a desired output flow rate and adjusts the intensity of the heating element to obtain the desired flow rate of the liquid sample.

16. The evaporative membrane device according to claim 1 wherein the controller adjusts the intensity of the heating element through regulation of the power supply to the heating element.

17. A method of concentrating analytes and/or altering solvent mixture of an analyte composition comprising:
i) flowing a liquid sample stream comprising an analyte composition and one or more solvents into an evaporative membrane concentration module comprising a heating element;
ii) measuring the output flow rate of the liquid sample stream from the module;
iii) controlling the intensity of the heating element to evaporate solvent from the analyte composition and provide a desired output flow rate of the liquid sample stream from the module;
wherein the heating element is situated to heat the flow of liquid sample stream within the evaporative membrane concentration module.

18. A method of interfacing a first liquid flow process and a second liquid flow process, the first and second liquid flow processes having incompatibility in liquid phase composition or flow rate comprising placing an evaporative membrane modulation device according to claim 1 between the first and the second liquid flow process.

19. The method according to claim 18 wherein the first liquid flow process is an extraction process or a chromatography process or wherein the second liquid flow process is selected from a chromatography process and a detection process or wherein the first liquid flow process is an extraction process or a chromatography process and the second liquid flow process is selected from a chromatography process and a detection process.

20. (canceled)

21. The method according to claim 18 wherein the first liquid flow process is an extraction process selected from liquid-liquid extraction and a solid phase extraction and the second liquid flow process is a chromatography process.

22. The method according to claim 18 wherein both the first and second liquid flow processes are chromatography processes.

23. A method of multi-dimensional liquid chromatography comprising interfacing an evaporative membrane modulation device according to claim 1 between a first chromatographic separation and a second chromatographic separation.

24. The method according to claim 23 wherein the multi-dimensional liquid chromatography is two, three or four dimensional liquid chromatography.

25. The method according to claim 23 wherein the multi-dimensional chromatography comprises combinations of high performance liquid chromatography, reverse phase liquid chromatography, ion exchange chromatography, size exclusion chromatography, normal phase chromatography, hydrophilic interaction chromatography, argentation chromatography or liquid chromatography under critical conditions.

26. A multi-dimensional chromatographic instrument comprising at least one evaporative membrane modulation device according to claim 1.
